(19) United States
(12) Patent Application Publication
(10) Pub. No.: US 2016/0288931 A1
(43) Pub. Date: Oct. 6, 2016

(54) SATELLITE FRAME AND METHOD OF MAKING A SATELLITE

(71) Applicant: WorldVu Satellites Limited, St Helier (GB)

(72) Inventors: Daniel W. Field, Sunnyvale, CA (US); Armen Askijian, Sunnyvale, CA (US); James Grossman, Sunnyvale, CA (US); Alexander D. Smith, San Jose, CA (US)

(21) Appl. No.: 14/675,542

(22) Filed: Mar. 31, 2015

(51) Int. Cl. B64G 99/00; B29C 70/06; B29C 70/30; B64G 1/10; B64G 1/28

(52) U.S. Cl. CPC B64G 9/00; B64G 1/10; B64G 1/283; B29C 70/30; B29C 70/06; B29K 2063/00

(57) ABSTRACT

A satellite frame includes a one-piece integrated body defining a plurality of sides for attaching satellite components thereto. Use of the single integrated satellite body minimizes the amount of fasteners and alignment equipment and processes. Use of the single piece frame also allows for the maximum possible specific stiffness by greatly reducing the number of connections and structural interfaces.

### TECHNICAL FIELD

The present invention is related to satellites, and in particular, structural design for LEO and MEO satellites.

### BACKGROUND OF THE INVENTION

Legacy satellite structural design typically consists of multiple panels, decks, longerons, ribs and brackets which are attached to each other to form a closed shape that defines a set of planar surfaces. A typical shape would be a rectangular or hexagonal prism.

A significant problem with such a design is that it uses multiple parts and fasteners, and requires a large amount of fixtures, support tooling and hand labor. Every joint adds additional fastener and doubler mass, and creates a potentially soft node that decreases the overall structural rigidity. Moreover, once the satellite has been assembled, it typically requires post assembly alignment and complex calibration procedures.

Every step in such a process is expensive and time consuming. However, what may be even more important than time and money is that the legacy design causes an increase in failure rate and misalignment issues when the satellites are in orbit. As can be appreciated, repairing a satellite when it's in already in orbit can be very difficult.

Therefore, there is a need to provide a satellite structural design which substantially reduces alignment issues, failure rates and complexity as well as cost and time for assembly.

### SUMMARY OF THE DISCLOSURE

According to one aspect of the present invention, a satellite frame has a one-piece body defining a plurality of sides for attaching a plurality of satellite components.

According to another aspect of the present invention, a method of making a satellite is provided. A one-piece integrated frame defining a plurality of sides is formed. Once the frame is formed, panels are attached to the sides of the frame with each panel supporting at least one satellite component.

Advantageously, use of the single integrated satellite body frame minimizes the amount of fixtures, fasteners and alignment equipment and processes which yields a lighter design and which is quicker to integrate design. Use of the single piece frame also allows for the maximum possible specific stiffness by greatly reducing the number of connections and structural interfaces.

Moreover, one particularly important benefit is the improved alignment of components relative to each other and the reduced likelihood of misalignment once the satellite is operational in an orbit where repair may be very difficult. As a result, the present invention substantially reduces the cost of operating satellites.

### BRIEF DESCRIPTION OF THE DRAWINGS

FIG. 1 depicts a perspective view of a satellite in accordance with one aspect of the present invention.

FIG. 2 depicts an exploded perspective view of some parts of the satellite of FIG. 1.

FIG. 3 depicts a perspective view of a single integrated satellite frame in accordance with an aspect of the present invention.

FIGS. 4A and 4B depict two lateral sides of the satellite frame of FIG. 3.

### DETAILED DESCRIPTION OF THE INVENTION

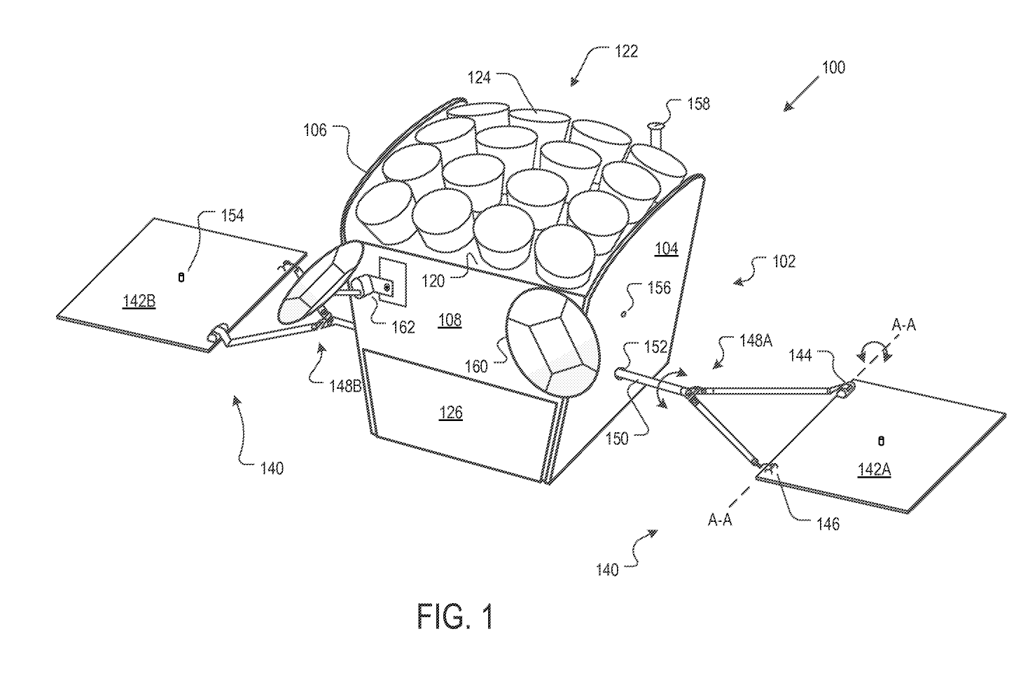

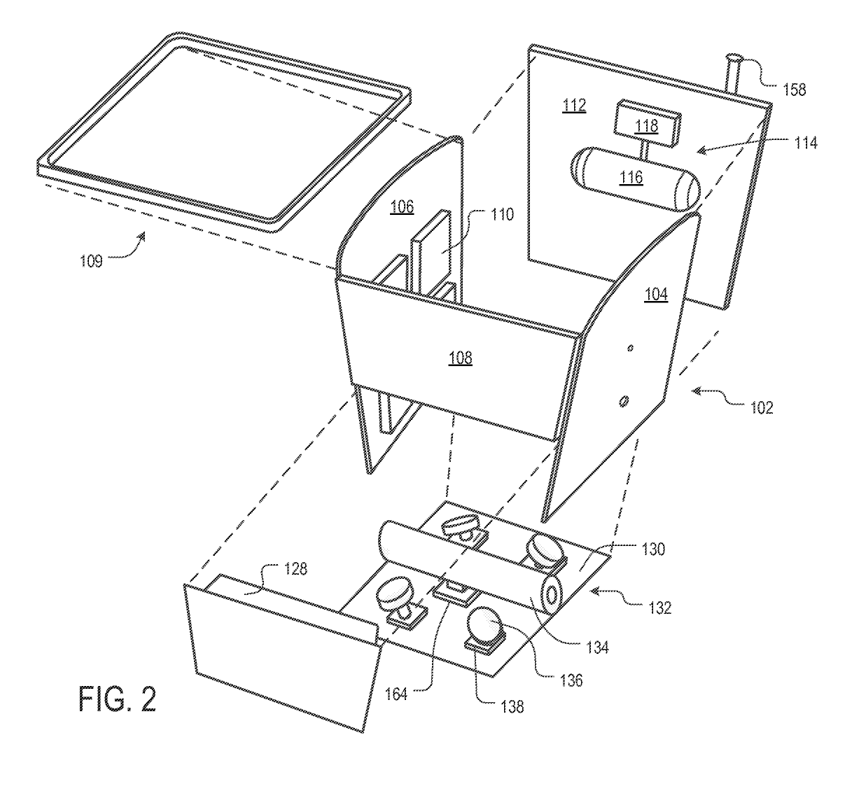

FIG. 1 depicts satellite 100 in accordance with the present teachings. FIG. 2 depicts an “exploded” view of some of the salient features of satellite 100. Referring now to both FIGS. 1 and 2, satellite 100 includes unified payload module 102, propulsion module 114, payload antenna module 122, bus component module 132, and solar-array system 140, arranged as shown. It is to be noted that the orientation of satellite 100 in FIGS. 1 and 2 is “upside down” in the sense that in use, antennas 124, which are facing “up” in the figures, would be facing “down” toward Earth.

Unified payload module 102 comprises panels 104, 106, and 108. In some embodiments, the panels are joined together using various connectors, etc., in known fashion. Brace 109 provides structural reinforcement for the connected panels.

Panels 104, 106, and 108 serve, among any other functionality, as radiators to radiate heat from satellite 102. In some embodiments, the panels include adaptations to facilitate heat removal. In some embodiments, the panels comprise plural materials, such as a core that is sandwiched by face sheets. Materials suitable for use for the panels include those typically used in the aerospace industry. For example, in some embodiments, the core comprises a lightweight aluminum honeycomb and the face sheets comprise 6061-T6 aluminum.

Propulsion module 114 is disposed on panel 112, which, in some embodiments, is constructed in like manner as panels 104, 106, and 108 (e.g., aluminum honeycomb core and aluminum facesheets, etc.). Panel 112, which is obscured in FIG. 1, abuts panels 104 and 106 of unified payload module 102.

Propulsion module 114 includes fuel tank 116 and propulsion control system 118. The propulsion control system controls, using one or more valves (not depicted), release of propulsion gas through the propulsion nozzle (not depicted) that is disposed on the outward-facing surface of panel 114. Propulsion control system is appropriately instrumented (i.e., software and hardware) to respond to ground-based commands or commands generated on-board from the control processor.

Payload antenna module 122 comprises a plurality of antennas 124. In the illustrative embodiments, sixteen antennas 124 are arranged in a 4×4 array. In some other embodiments, antennas 124 can be organized in a different arrangement and/or a different number of antennas can be used. Antennas 124 are supported by support web 120. In some embodiments, the support web is a curved panel comprising carbon fiber, with a suitable number of openings (i.e., sixteen in the illustrative embodiment) for receiving and supporting antennas 124.

In some embodiments, antennas 124 transmit in the Kᵤ band, which is the 12 to 18 GHz portion of the electromagnetic spectrum. In the illustrative embodiment, antennas 124 are configured as exponential horns, which are often used for communications satellites. Well known in the art, the horn antenna transmits radio waves from (or collects them into) a waveguide, typically implemented as a short rectangular or cylindrical metal tube, which is closed at one end and flares into an open-ended horn (conical shaped in the illustrative embodiment) at the other end. The waveguide portion of each antenna 124 is obscured in FIG. 1. The closed end of each antenna 124 couples to amplifier(s) (not depicted in FIGS. 1 and 2; they are located on the interior surface of panel 104 or 108).

Bus component module 132 is disposed on panel 130, which attaches to the bottom (from the perspective of FIGS. 1 and 2) of the unified payload module 102. Panel 130 can be constructed in like manner as panels 104, 106, and 108 (e.g., aluminum honeycomb core and aluminum facesheets, etc.). In some embodiments, panel 130 does not include any specific adaptations for heat removal.

Module 132 includes main solar-array motor 134, four reaction wheels 136, and main control processor 164. The reaction wheels enable satellite 100 to rotate in space without using propellant, via conservation of angular momentum. Each reaction wheel 136, which includes a centrifugal mass (not depicted), is driven by an associated drive motor (and control electronics) 138. As will be appreciated by those skilled in the art, only three reaction wheels 136 are required to rotate satellite 100 in the x, y, and z directions. The fourth reaction wheel serves as a spare. Such reaction wheels are typically used for this purpose in satellites.

Main control processor 164 processes commands received from the ground and performs, autonomously, many of the functions of satellite 100, including without limitation, attitude pointing control, propulsion control, and power system control.

Solar-array system 140 includes solar panels 142A and 142B and respective γ-bars 148A and 148B. Each solar panel comprises a plurality of solar cells (not depicted; they are disposed on the obscured side of solar panels 142A and 142B) that convert sunlight into electrical energy in known fashion. Each of the solar panels includes motor 144 and passive rotary bearing 146; one of the γ-bar attaches to each solar panel at motor 144 and bearing 146. Motors 144 enable each of the solar panels to at least partially rotate about axis A-A. This facilitates deploying solar panel 142A from its stowed position parallel to and against panel 104 and deploying solar panel 142B from its stowed position parallel to and against panel 106. The motors 144 also function to appropriately angle panels 142A and 142B for optimal sun exposure via the aforementioned rotation about axis A-A.

Member 150 of each γ-bar 148A and 148B extends through opening 152 in respective panels 104 and 106. Within unified payload module 102, members 150 connect to main solar-array motor 134, previously referenced in conjunction with bus component module 132. The main solar-array motor is capable of at least partially rotating each member 150 about its axis, as shown. This is for the purpose of angling solar panels 142A and 142B for optimal sun exposure. In some embodiments, the members 150 can be rotated independently of one another; in some other embodiments, members 150 rotate together. Lock-and-release member 154 is used to couple and release solar panel 142A to side panel 104 and solar panel 142B to side panel 106. The lock-and-release member couples to opening 156 in side panels 104 and 106.

Satellite 100 also includes panel 126, which fits “below” (from the perspective of FIGS. 1 and 2) panel 108 of unified payload module 102. In some embodiments, panel 108 is a sheet of aerospace grade material (e.g., 6061-T6 aluminum, etc.) Battery module 128 is disposed on the interior-facing surface of panel 126. The battery module supplies power for various energy consumers onboard satellite 100. Battery module 128 is recharged from electricity that is generated via solar panels 142A and 142B; the panels and module 128 are electrically coupled for this purpose (the electrical path between solar panels 142A/B and battery module 128 is not depicted in FIGS. 1 and 2).

Satellite 100 further includes omni-directional antenna 158 for telemetry and ground-based command and control.

Disposed on panel 108 are two “gateway” antennas 160. The gateway antennas send and receive user data to gateway stations on Earth. The gateway stations are in communication with the Internet. Antennas 160 are coupled to panel 108 by movable mounts 162, which enable the antennas to be moved along two axes for optimum positioning with ground-based antennas. Antennas 160 typically transmit and receive in the Kₐ band, which covers frequencies in the range of 26.5 to 40 GHz.

Convertor modules 110, which are disposed on interior-facing surface of panel 106, convert between Kₐ radio frequencies and Kᵤ radio frequencies. For example, convertor modules 110 convert the Kₐ band uplink signals from gateway antennas 160 to Kᵤ band signals for downlink via antennas 124. Convertor modules 110 also convert in the reverse direction; that is, Kᵤ to Kₐ.

In operation of satellite 100, data flows as follows for a data request:
(obtain data): requested data is obtained from the Internet at a gateway station;
(uplink): a data signal is transmitted (Ka band) via large, ground-based antennas to the satellite's gateway antennas 160;
(payload): the data signal is amplified, routed to convertor modules 110 for conversion to downlink (Ku) band, and then amplified again;
the payload signal is routed to payload antennas 124;
(downlink): antennas 124 transmit the amplified, frequency-converted signal to the user's terminal.
   When a user transmits (rather than requests) data, such as an e-mail, the signal follows the same path but in the reverse direction.

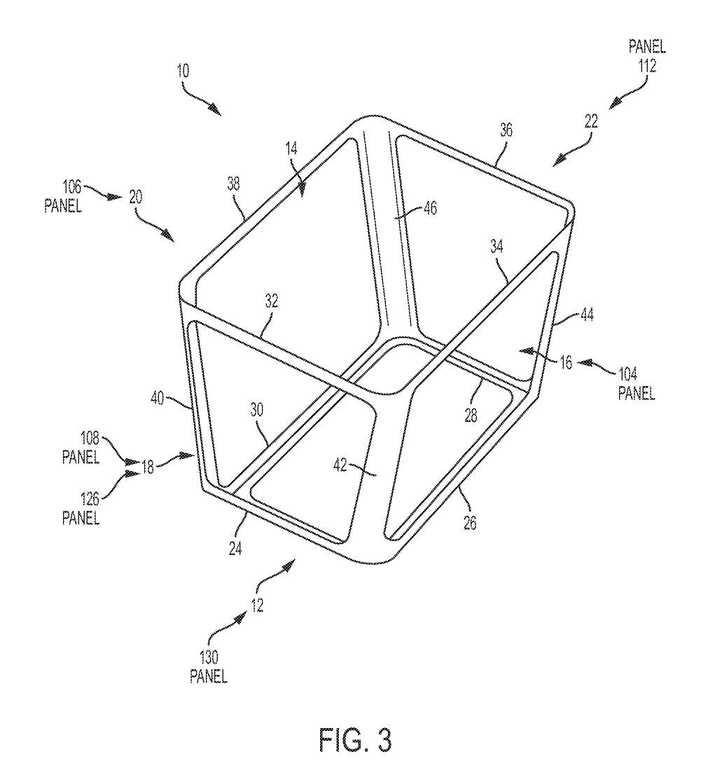

FIG. 3 depicts a perspective view of a single integrated satellite frame 10 in accordance with an aspect of the present invention. As shown, the frame 10 is designed for a LEO (low earth orbit) satellite, which is intended to be one of at least several hundred identical satellites that provide telephone and internet connectivity to areas that are not currently served by wire lines. However, the principles disclosed herein can be applied equally to other types of satellites including MEO, geosynchronous and geostationary satellites.

The frame 10 is a unitized frame comprising support beams 24-46 that are integrally formed and interconnected to each other to define six sides 12-22. The term unitized frame or unibody frame for purposes of the present application means a single integrally formed body or frame. Each of the six sides 12-22 is a quadrilateral in the embodiment shown.

Support beams 24-30 define a bottom side 12 and beams 32-38 define a top side. A group of support beams (24,32,40 and 42), (26,34,42 and 44), (28,36,44 and 46) and (30,38,40 and 46) each respectively define one of four lateral sides 16-22. As discussed earlier, when the satellite is operational in orbit, the frame 10 will be turned upside down such that the bottom side 12 will be facing the Earth while the top side 14 will be facing away from the Earth.

Optionally, to increase structural integrity of the frame 10, a rectangular brace 109 (shown in FIG. 2) could be attached to the top side 14 around beams 32-38 by a fastener such as bolts and nuts. The brace 109 can be made of strong, light weight material such as Aluminum or an Aluminum alloy such as 6061 Aluminum alloy (6061-T6 in particular).

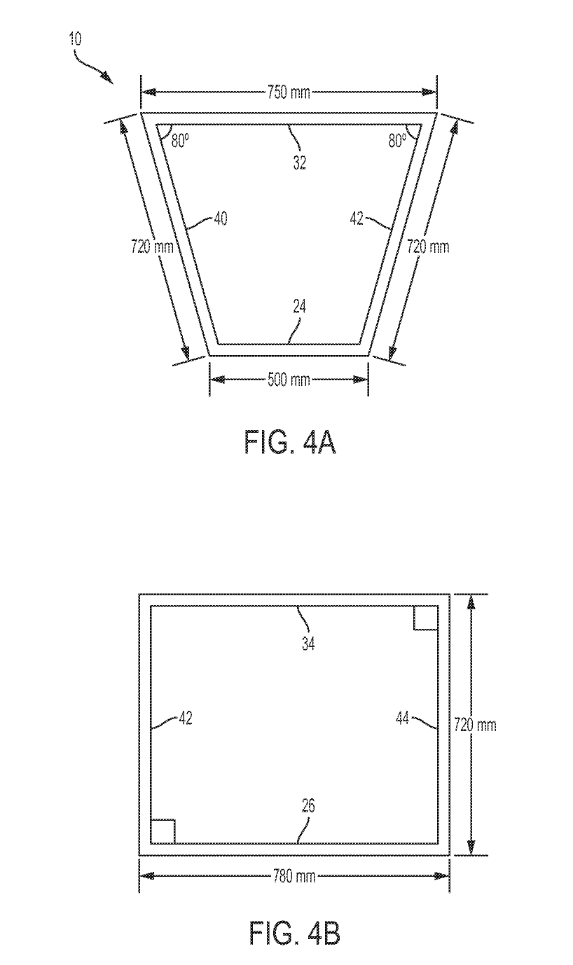

In the embodiment shown, lateral sides 16 and 20 (as shown in FIG. 4B), and bottom and top sides 12 and 14 are rectangular in shape, whereas lateral sides 18 and 22 (as shown in FIG. 4A) are isosceles-trapezoidal in shape. The angle formed between beams 32 and 40 as well as beams 32 and 42 is about 80 degrees in this embodiment.

The bottom side 12 measures about 500 mm by 780 mm while the top side 14 measures about 750 mm by 780 mm. The lateral sides 18 and 22 measure about 500 mm by 720 mm by 750 mm by 720 mm while sides 16 and 20 measure about 780 mm by 720 mm.

The bottom panel 130 and side panels 104,112,106,108 and 126 are attached to the frame 10 using known fastening methods such as bolts and nuts (not shown). The bolt heads are countersunk into the panels and nuts or nut plates reside inside the frame 10.

The panels can be made of the same material as the rectangular brace 109. Accordingly, they can be Aluminum or an Aluminum alloy such as 6061 Aluminum alloy (6061-T6 in particular).

According to an aspect of the present invention, the frame 10 can be made from any material having the tensile strength and modulus to withstand the static and dynamic forces applied during the satellite launch. The unibody frame 10 can be constructed from either composite or metallic materials via molding, forming, stamping, machining, or the like. The unibody approach is particularly conducive to the use of fibrous composites as the entire unibody can be co-cured on a single mold and the fiber orientations can be locally tailored for the optimal satellite stiffness.

Materials such as aluminum, steel, synthetic fiber, glass fiber and carbon fiber material can be used, for example. Preferably, the frame 10 includes carbon fiber material, which is strong, stiff and light weight.

More particularly, the frame 10 can be a single integrated molded piece from carbon fiber pre-preg material. One exemplary carbon fiber pre-preg material consists of T700 carbon fiber impregnated with RS-36 epoxy resin, which is available from TenCate Aerospace Composites of Morgan Hill, Calif. The frame 10 includes a quasi-isotropic layup of unidirectional plies of the carbon fiber pre-preg. With this type of layout, the carbon fiber frame 10 advantageously provides a structural strength which is similar to Aluminum and yet provides a 40% saving in weight.

A method of making the frame 10 will now be discussed.

First, a mold for the frame 10 is formed. Because the carbon fiber pre-preg material is typically cured around 120-180° C., the mold material should be able to withstand such high temperature without softening, distorting or deteriorating. The resin used in the prepreg is epoxy and so it is also important that the mold material is compatible with epoxy resin. For these reasons, the preferred materials for the mold include high temperature epoxy, metal such as aluminum or stainless steel or a high temperature vinyl ester resin.

Once the mold has been made, raw carbon fiber plies are pressed firmly into the mold to ensure that any tight corners of the mold are closely covered without any voids. The carbon fiber material can be a single laminate containing multiple woven plies. Alternatively, the carbon fiber material can be multiple unidirectional plies, in which case the plies should be placed over the mold at different angles that form a specified pattern, such as quasi-isotropic. In either case, the mold is then placed in a vacuum bag and air is evacuated out of the bag. This ensures that ambient air pressure will exert a force on every part of the carbon fiber plies to compact them during cure.

The vacuum bag containing the mold is then cured in an oven at a specified temperature ramp and duration for the particular type of material being cured. After curing, the carbon fiber plies are removed from the mold. The carbon fiber plies are finished into a frame 10 by drilling all holes and machining as needed.

The resulting frame 10 provides a structural unitized body that provides the basic geometric skeleton of the satellite bus structure in a single, integral component. As all of the panels and components are assembled, directly or indirectly, to the single integrated body frame 10, the use of a single unitized frame body 10 minimizes the amount of fixtures, fasteners and alignment equipment and processes which yields a lighter and quicker integrated design. Moreover, the use of the single piece frame allows for the maximum possible specific stiffness by greatly reducing the number of connections and structural interfaces.

Also, all primary flight loads are directly reacted and transmitted through the unibody frame 10. This allows for semistructural and secondary connections to support all radiators and components and forces all major launch loads down the stiffest load path, which maximizes the global effect of the unibody frame 10 while minimizing the launch stresses seen in all secondary members.

Of particularly important benefit is the improved alignment of components relative to each other. Conventionally, if the frame 10 were made of beams that are simply bolted to each other, alignment between components becomes very difficult. More significantly, even if the components were properly aligned on the ground, they could drift out of alignment during launch or operation in orbit where repair becomes extremely difficult.

For example, in FIG. 1, antennas 106 are supported on the support web 120 while the reaction wheels that control the position of the satellite are on panel 130. The panels 130 and support web 120 are separated from each other by the beams 40-46. If the beams are separately attached to each other and to the beams forming the bottom and top sides, there is a substantially greater likelihood of the panel 130 becoming misaligned with the support web 120.

By contrast, according to the present invention, all of the panels are connected to the common single integrated frame 10. As such, the likelihood of any misalignment between panels and between any two components is greatly reduced.

It is to be understood that the disclosure describes a few embodiments and that many variations of the invention can easily be devised by those skilled in the art after reading this disclosure. For example, while the inventive concepts disclosed herein are particularly suited to LEO and MEO satellites, they can also apply to larger higher orbit satellites. Accordingly, the scope of the present invention is to be determined by the following claims.

What is claimed is:

1. A satellite frame comprising a one-piece body defining a plurality of sides for attaching a plurality of satellite components.

2. The satellite frame of claim 1, wherein the body includes a plurality of interconnected beams to define six sides.

3. The satellite frame of claim 2, wherein each of the six sides is a quadrilateral.

4. The satellite frame of claim 1, wherein the plurality of sides receive a plurality of panels and one of the panels supports a plurality of reaction wheels for controlling the orientation of the satellite and another one of the panels supports at least one antenna.

5. The satellite frame of claim 1, wherein the body contains carbon fiber material.

6. The satellite frame of claim 5, wherein the body contains a quasi-isotropic layup of unidirectional plies of the carbon fiber material.

7. The satellite frame of claim 1, wherein the body contains carbon fiber prepreg material.

8. The satellite frame of claim 1, wherein the body contains one or more of the following materials: glass fiber, synthetic fiber, Aluminum and steel.

9. A LEO satellite frame comprising a one-piece molded body defining at least three sides for attaching a plurality of panels that support a plurality of satellite components.

10. The LEO satellite frame of claim 9, wherein the at least three sides receive a plurality of panels and one of the panels supports a plurality of reaction wheels for controlling the orientation of the satellite and another one of the panels supports at least one antenna.

11. The LEO satellite frame of claim 9, wherein the body contains carbon fiber material.

12. The LEO satellite frame of claim 11, wherein the body contains a quasi-isotropic layup of unidirectional plies of the carbon fiber material.

13. The LEO satellite frame of claim 9, wherein the body contains carbon fiber prepreg material.

14. The LEO satellite frame of claim 9, wherein the body contains one or more of the following materials: glass fiber, synthetic fiber, Aluminum and steel.

15. The LEO satellite frame of claim 9, wherein the volume defined by the body is one cubic meter or less.

16. A method of making a satellite comprising:
forming a one-piece integrated frame defining a plurality of sides;
attaching a plurality of panels to the sides with each panel supporting at least one satellite component.

17. The method of claim 16, wherein the step of forming the frame includes:
laying composite fiber material in a frame mold;
solidifying the laid fiber material to form the one-piece integrated molded frame.

18. The method of claim 16, wherein the step of forming the frame includes:
laying composite carbon fiber material in a frame mold;
curing the laid fiber material to form the one-piece integrated molded frame in an oven.

19. The method of claim 18, wherein the step of laying composite carbon fiber material includes laying a carbon fiber pre-preg laminate that define a quasi-isotropic layup of unidirectional plies.

20. The method of claim 16, wherein the step of attaching includes:
attaching, to one side of the frame, one panel supporting a plurality of reaction wheels for controlling the orientation of the satellite; and
attaching, to another side of the frame, another panel supporting at least one antenna.
